(19) United States
(12) Patent Application Publication
(10) Pub. No.: US 2010/0121583 A1
(43) Pub. Date: May 13, 2010

(54) METHOD FOR MEASUREMENT OF IN-SITU VISCOSITY

(75) Inventors: Scot D. Abbott, Pittsburgh, PA (US); David M. Groski, Hockessin, DE (US); Scott Christopher Jackson, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DuPont de Nemours and Company, Wilmington, DE (US)

(21) Appl. No.: 12/270,307

(22) Filed: Nov. 13, 2008

(51) Int. Cl. G01N 11/14; G01N 31/00; G01N 37/00

(52) U.S. Cl. 702/50; 436/2; 73/1.03

(57) ABSTRACT

A method for measuring in-situ the viscosity of a fluid within a vessel using an apparatus using a motor driven impeller paddle immersed in the fluid. A chemical or biological agent is added to the fluid. The impeller paddle is rotated and the rotational positions of impeller drive shaft and the paddle are sensed. The rotational speed of the shaft is determined and the deflection angle of the impeller paddle relative to the shaft is determined. The viscosity of the fluid is determined by a computer from a look up table containing deflection angle for fluids of known viscosities. The measurements are periodically repeated for a predetermined number of iterations to determine the change in viscosity caused by reaction of the fluid with the chemical or biological agent and the results are reported to a user.

### FIELD OF THE INVENTION

The field of the invention is a method to measure the viscosity of a fluid in-situ, such as in a sealed vessel or in a batch reactor or in a flow reactor. The fluid can be a single phase or multiphase fluid, such as a hydrocarbon compound and water in a bacterial enrichment culture.

### BACKGROUND OF THE INVENTION

Certain anaerobic bacteria are known to have an ability to metabolize certain hydrocarbon molecules, such as those found in crude petroleum. The anaerobic bacteria break bonds in the hydrocarbon molecule, which results in a reduction of the viscosity of the crude petroleum. To evaluate the action of these anaerobic bacteria, samples of crude petroleum or petroleum and water mixtures are inoculated with an anaerobic bacteria to create an enrichment culture and then tested under controlled temperature conditions over a period of time. Samples are removed periodically from the culture and tested to measure viscosity using prior art methods. This prior art methodology is believed disadvantageous because the sampling disturbs the environment of the culture and results in a reduction in liquid volume. This volume reduction necessitates either larger volume cultures or multiple cultures of a given sample in order to sacrifice a portion of the sample for the viscosity measurement.

An instrument known as a viscometer is employed to measure the viscosity of a fluid. A number of commercial viscometers are available from a number of vendors, for example, Rheotek, Brookfield or Hydramotion. Using a typical batch viscometer, the fluid material of interest is placed into a cup and a probe is moved in the fluid within the cup. The drag on the probe from the fluid surrounding it can be translated to viscosity. Although some viscometers can use volumes as low 10 cubic centimeters (cc), they are expensive, and are difficult to adapt to sealed vessels such as those used to incubate enrichment cultures.

When using an in-line viscometer, the fluid material of interest is pumped through a chamber that contains the probe. For example, U.S. Pat. No. 4,750,351 discloses an in-line viscometer that measures a pressure drop across a fixed flow resistance element. This type of viscometer is difficult to adapt to a sealed vessel such as those used to incubate enrichment cultures.

Another viscosity measurement technique as described in U.S. Pat. No. 5,203,203, uses a spherical ball placed in direct contact with a fluid in a sealed container. The viscosity measurement is effected by measuring the speed at which the ball falls through the liquid. Although potentially adaptable to sealed vessels such as those used to incubate enrichment cultures, a difficulty is encountered with using a spherical ball and controlling its location in order to keep it within the hydrocarbon phase of a multi-phase enrichment culture.

Prior art methods and apparatus suffer from a number of deficiencies. Prior art methods and apparatus typically do not provide a means to measure the viscosity as a function of rate of shear. The falling ball technique provides no means to independently agitate the fluid in the sealed vessel without disturbing the movement of the spherical ball that is used to measure viscosity.

Consequently, there is a need to provide an inexpensive method to measure viscosity in-situ in sealed vessels under a variety of shear conditions. There is also a need for a method to measure viscosity in the hydrocarbon phase of an enrichment culture without the need to remove samples from the culture. Another need is for a method to measure viscosity that is not disturbed by any agitation that is required for the enrichment culture or the reaction that is occurring in the sealed vessel. Another need is for a method capable of measuring viscosity in the hydrocarbon phase and not the water phase of the enrichment culture. Another need is for a method that readily accommodates multiple sealed vessels so that both control cultures (or control reactions) and replicate cultures (or replicate reactions) can be run in parallel at the same time under identical conditions.

### SUMMARY OF THE INVENTION

A method of measuring viscosity of a fluid in a vessel while chemically or biologically reacting the fluid with an agent, comprising the steps of:
a) placing a fluid material of interest in a generally cylindrical vessel containing an impeller assembly, the impeller assembly comprising: i) a generally planar impeller paddle, ii) a shaft, iii) a torsional spring, and iv) a drive motor;
b) adding a chemical or biological agent to the fluid material;
c) purging the cylindrical vessel with a desired reaction atmosphere and reacting the reaction agent with the fluid;
d) rotating the impeller paddle at a predetermined rotational speed;
e) sensing the rotational position of the shaft and the rotational position of the impeller paddle;
f) determining the rotational speed of the shaft from the sensed rotational position;
g) determining the deflection angle of the impeller paddle relative to the shaft;
h) determining the viscosity of the fluid from the deflection angle and the rotational speed of the shaft;
i) periodically repeating steps d) through h) for a predetermined number of iterations; and
j) reporting the results to a user.

The calibration of the apparatus for measuring viscosity of a fluid in a vessel is performed by practicing the measurement method in accordance with the invention for a number of fluids having known viscosities, compiling the known viscosities, the deflection angles and the shaft speeds in a look up table stored in a storage device and then accessing the look up table with a computer to determine the viscosity of a fluid. The viscosity may be measured in situ in a sealed vessel without loss of sample or affect on reaction or reactants in the vessel.

### BRIEF DESCRIPTION OF THE FIGURES

FIG. 1 is a diagrammatic view showing the components of the apparatus in accordance with the present invention;

FIG. 2 is a pictorial view showing a viscosity measurement module in accordance with the present invention;

FIG. 3A is a sectional view showing details of construction of a rotating impeller assembly of the viscosity measurement module;

FIG. 3B is an exploded view of selected components of FIG. 3A;

FIG. 4 is a block diagram view showing the overall operation of the apparatus;

FIG. 5 is a timing diagram showing the signals used to measure the shaft rotational speed and deflection angle of the paddle;

FIG. 6 is a block diagram view showing the steps of a method carried out in accordance with the invention to determine relative viscosity;

FIGS. 7A and 7B are plots that illustrate how the apparatus was calibrated using Newtonian fluids of known viscosities;

FIG. 8 is a plot that illustrates the use of the apparatus for an un-inoculated control using fluids with and without water present and measuring their relative viscosities over a period of time; and

FIG. 9 is a plot that illustrates the use of the apparatus for an inoculated experiment that shows viscosity changes over time and the resulting evaporative losses of light components in the oil.

### DETAILED DESCRIPTION OF THE INVENTION

The present method is arranged to facilitate the automated measurement of viscosity of a plurality of enrichment culture samples, each in a sealed vessel, without the need to remove any sample material from the sealed vessel or to disturb the environment within the vessel using the apparatus described below.

A viscosity measurement system 1 comprises a plurality of viscosity measurement modules 10 and a control and measurement system 100. A viscosity measurement module 10 comprises an agitator assembly 20, a shaft 30 and a drive motor 40. The shaft 30 has an axis 30A, a first end 30B, a second end 30C and a middle region 30M. The shaft 30 is supported in its middle region 30M in a bushing 50B mounted to a containment vessel 50. The agitator assembly 20 comprises a paddle 22 and a low torsion helical spring 24. The paddle 22 is mounted on the shaft 30 adjacent to the first end 30A for rotatable motion. The low torsion helical spring 24 has an axis 24A, a first end 24B and a second end 24C. The first end 24B of the spring 24 is connected to the paddle 22 and the second end 24C end of the spring is connected to the shaft 30, as will be described. The second end 30B of the shaft 30 is connected to the drive motor 40 by a coupling 42.

A position sensor assembly 60 comprises a shaft position sensor unit 62 and a paddle position sensor unit 72. The shaft position sensor unit 62 comprises a magnet 64 mounted on the shaft 30 and a magnetic field detector 66 known as a “Hall-effect sensor” mounted near the shaft 30. The paddle position sensor unit 72 comprises a magnet 74 mounted on the paddle 22 and a Hall-effect sensor 76 mounted near the paddle 22. The magnets 64 and 74 are typically rare earth magnets. When the magnets 64, 74 pass by the respective Hall-effect sensors 66, 76 the Hall-effect sensors generate electrical signals.

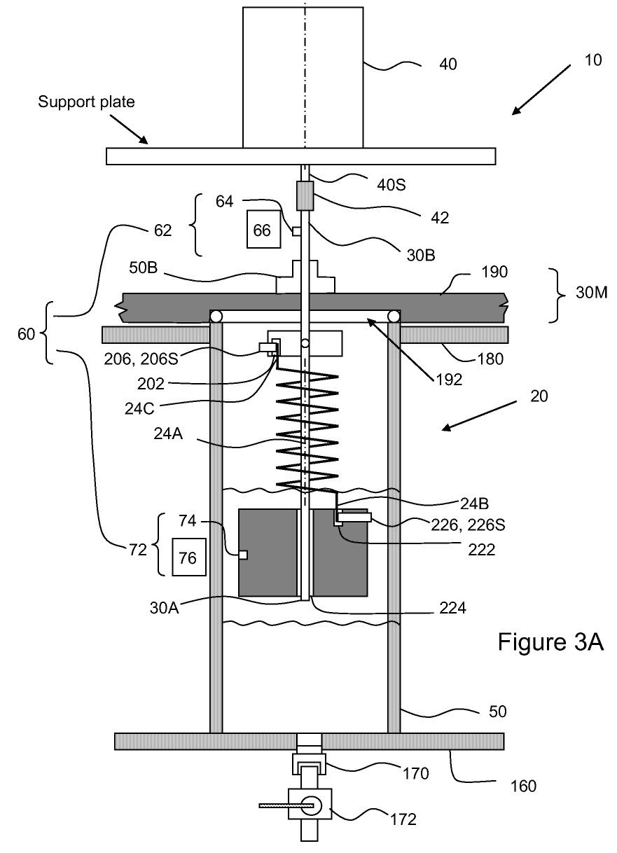

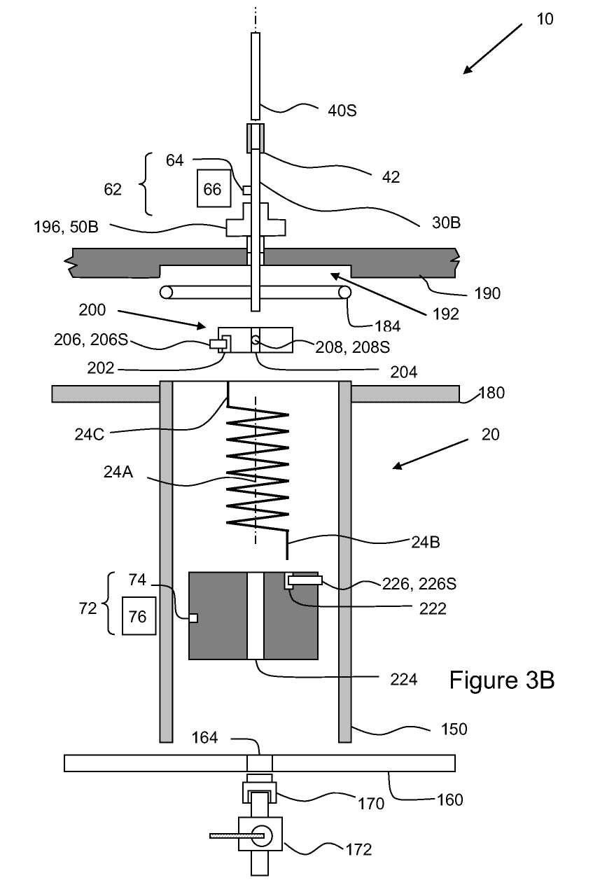

The paddle 22 is mounted on the shaft 30 in such a way that it can freely rotate about the shaft and is driven for rotation by the torsion spring 24 (see FIG. 3). The paddle 22, the spring 24 and the shaft 30 are configured so that when the paddle 22 is rotated away (i.e., deflected) from its equilibrium position on the shaft 30 it will readily spring back to its equilibrium position when the rotational force is removed.

The agitator assembly 20 is mounted in a vessel 50 that contains the fluid of interest. The fluid of interest may be any single phase or multiple phase liquid. A chemical or biological agent may be added to the fluid to cause the fluid to chemically react or to change its physical state, such as a change in it viscosity. The additive agent for instance may contain a bacterium innoculum such as that described in conjunction with Example 3. The fluid of interest is typically an enrichment culture comprising a multiple phase liquid (hydrocarbon and water) and a bacterium. The apparatus is arranged in such a way that the enrichment culture can be located around the agitator assembly and at a depth such that the agitator is immersed in the light phase (hydrocarbon phase) of the enrichment culture.

A plurality of viscosity measurement modules 10 may be connected to a control and measurement system 100 for simultaneous use.

### Description of the Apparatus

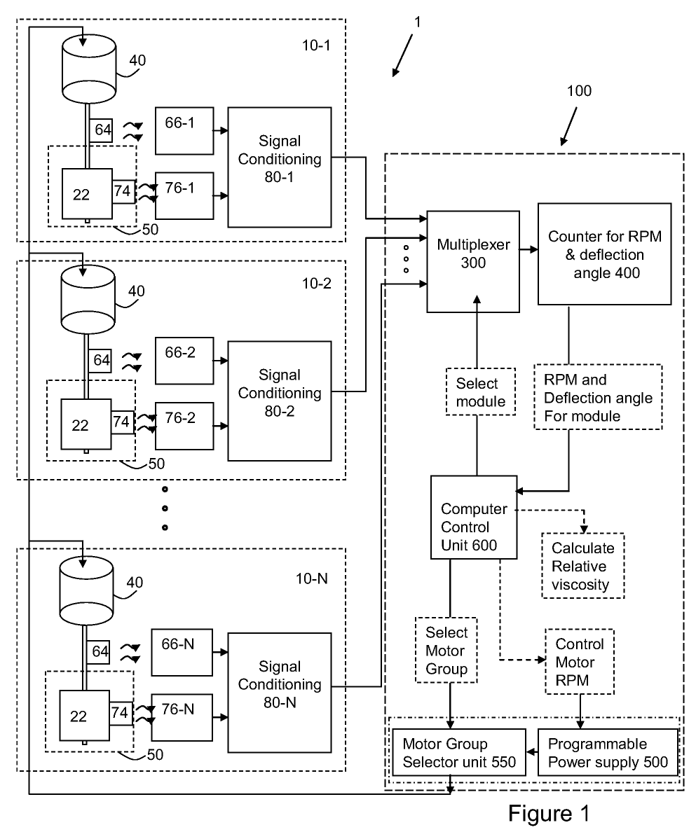

Referring to FIG. 1, a system 1, comprising a plurality of viscosity measurement modules 10-1 through 10-N and a control and measurement system 100 was constructed to permit simultaneous experiments and viscosity measurements to be carried out. Each viscosity measurement module 10 was electrically connected to the multiport control and measurement system 100. The control and measurement system 100 comprises a signal multiplexer 300, a counter circuit 400, a programmable power supply 500, a motor selector unit 550 and a computer control unit 600.

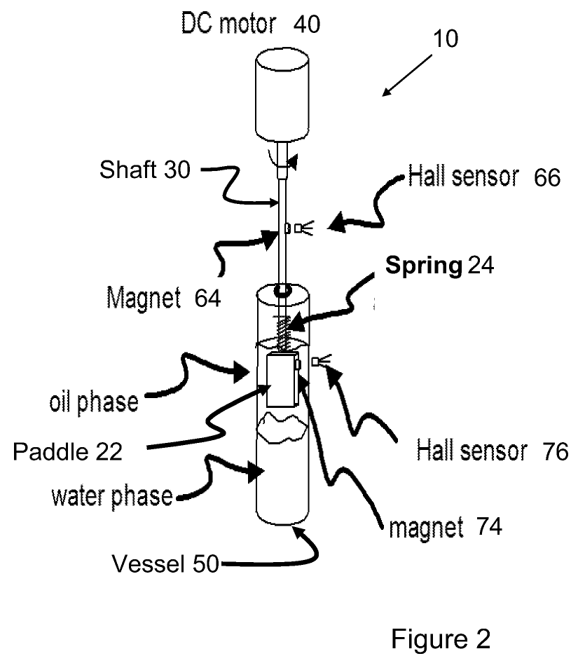

A well assembly comprising a plurality of viscosity measurement modules 10-1 through 10-N, as pictorially depicted in FIG. 2, was fabricated. Each viscosity measurement module 10 comprises a vessel 50 for holding a fluid of interest As may be seen in FIG. 3 each vessel 50 was made from a length of acrylic tubing having an inside diameter of 1.0 inch and an outside diameter of 1.5 inches, approximately 3.25 inches in length. A bottom end of each vessel 50 was formed by bonding the tube 150 (FIG. 3A) to an acrylic plate 160 approximately 0.3125 inches thick. The tubes were mounted in an array on this acrylic plate, the tubes being spaced about 1.625 inches center-to-center. A hole 164 (best seen in FIG. 3A) was drilled into the acrylic plate 160 at the center of each tube and tapped, typically with a ⅛ inch National Pipe Thread (NPT), to receive a threaded adapter 170, such as a male ⅛ inch pipe-to-male Luer Lock adapter (Swagelok Company 29500 Solon Road, Solon Ohio). A stop cock 172, typically a Biomedical Luer-fittng stop cock, from Popper & Sons, Inc, New Hyde Park, N.Y., was then mounted into the male Luer Lock end of the adapter 170 to permit filling and emptying each vessel 50-1 through 50-N.

The top of each acrylic tube 150 was bonded, using a suitable adhesive such as a solvent adhesive, to an acrylic top plate 180 approximately 0.3125 inch thick, having an array of 1.0 inch diameter bores 182 centered on each tube 150. This top plate 180 supports the top of the tubes 150 while provided access to each vessel 50-1 through 50-N. The top plate 180 was counter bored and machined to accept an O-ring 184, such as a part number 2-217 O-ring made by the Parker Hannifin Corporation, O-Ring Division, of Lexington, Ky. This O-ring was used to effect a seal to a 2.75 inch thick aluminum plate 190 that formed the top of all the vessels 50-1 through 50-N. Machined into this aluminum plate was an array of recesses 192 that were approximately 0.75 inches in diameter and 2.25 inches deep. These recesses were located on the underside of the plate 190 and were in communication with the volume of the vessels 50-1 through 50-N. These recesses 192 provide the volume necessary to hold the components of the agitator assembly 20, as will be described herein.

Holes 194 centered on each recess 192 were drilled into the top of the aluminum plate 190 above each vessel 50-1 through 50-N to provide access for the shaft 30. Each hole 194 was tapped, typically with a ⅛ National Pipe Thread (NPT), to accept a fitting 196, such as a male ⅛ inch pipe to ⅛ inch female swagelock tube fitting adapter (Swagelok Company, Solon Ohio) which served as a bushing 50B for each shaft 30.

Each shaft 30 was inserted into the female swagelock tube fitting 196, which permitted free rotation of the shaft. Each shaft 30 was made of a ⅛ inch diameter stainless steel tube approximately 6 inches long. Onto the shaft was mounted a small aluminum drive block 200 (FIG. 3A), approximately ⅝ inches long, 0.25 inches thick and 7/16 inches wide.

This block 200 was machined with a narrow slot 202 and a bore 204. The bore 204 was drilled to a diameter slightly larger than the shaft to allow it to slide along the ⅛ diameter stainless steel tubing. Two holes were drilled into this block 200. A first hole 206 was drilled to intersect the slot 202 and tapped to accept a 2-56 set screw. A second hole 208 was drilled through the block 200 into the bore 204 and also tapped to accept a 2-56 set screw 208S. A first 2-56 set screw 206S was threaded into the first hole 206 to affix a first end of the low torsional constant spring 24 in the slot 202. A spring having a part number TO-1114 spring, from Century Spring Corp. of Los Angeles, Calif. is suitable as spring 24. The second end 24C of the spring 24 was inserted in the slot 202 and secured with set screw 206S. When so mounted the spring 24 surrounds the ⅛ inch diameter stainless steel shaft 30 so that the spring's axis 24A was coincident with the shaft axis 30A and so that the first end 24B of the spring can rotate about the shaft 30 without binding.

The paddle 22 was machined from a block of aluminum plate approximately 0.25 inch thick, 0.9 inches long and 0.85 inches wide. A slot 222 and a bore 224 were machined into the paddle. The bore 224 was positioned at the center of the paddle along its longitudinal axis. The diameter of this bore (typically 9/64 inch) was such that the paddle 22 could freely rotate on the shaft 30. The slot 222 was machined into the paddle next to this bore to accept the first end 24B of the spring 24. A hole 226 was drilled to intersect the slot 222 and was threaded to accept a 2-56 set screw 226S. The paddle 22 was slid onto the shaft 30, the bore 224 permitting it to freely slide and rotate on the shaft 30. The first end 24B of the low torsional spring 24 was slid into the slot 222 on the side of the paddle and affixed to the paddle with the set screw 226S. In this manner, the paddle was free to rotate about the shaft 30 with only the torsional spring used to drive it for rotation. A recess approximately 0.125 inch in width by 0.125 inch deep was machined into one longitudinal edge of the paddle. Into this recess was press-fitted one or more 0.125 inch diameter by 0.0625 thick rare earth magnets 64, such as those available from Edmund Scientific of Barrington, N.J.

The portion of the shaft 30 adjacent to the first end 30B, the aluminum block 200, the torsional spring 24 and the paddle 22 thus constitute the agitator assembly 20. The shaft 30 was slid into the recess 192 machined into the aluminum plate 190 and into the male ⅛ inch pipe to ⅛ female swagelock tube fitting adapter 196. The height of the shaft 30 above the adapter 196 was adjusted so that the top of the paddle 22 extended down below the aluminum plate 190 by about ½ inch.

The height of the paddle 22 was fixed by attaching the shaft 30 to the shaft 40S of a DC motor 40, such as part number 253446 available from Jameco Electronics of Belmont, Calif. using common rubber tubing as a coupler 42. This DC motor 40 was mounted above the aluminum support plate 190, its drive shaft directed downward, on a support member such that its shaft 40S was aligned with the male ⅛ inch pipe to ⅛ female swagelok tube fitting adapter 50B that was mounted into the top of the aluminum plate 190. A 0.125 inch diameter by 0.0625 thick rare earth magnet 64 available from Edmund Scientific, was mounted to the shaft 30 just above the adapter 50B, typically with an epoxy adhesive.

An agitator assembly 20 and DC motor assembly 40, as described above, was installed for each vessel 50-1 through 50-N. After every agitator and DC motor was assembled and mounted onto the aluminum plate, the well assembly comprising the vessel 50-1 through 50-N was fastened onto the aluminum plate with the previously mentioned “O” rings making a seal between the top acrylic plate 180 and the aluminum top plate 190.

Each first Hall-effect sensor 66-1 through 66-N, such a part number A1321 EUA from Allegro MicroSystems. Inc. of Worcester, Mass., was mounted next to each rare earth magnet 64 on each drive shaft 30 of each respective module 10-1 through 10-N. Each second Hall-effect sensor 76-1 through 76-N was located outside the vessel 50 adjacent the rare earth magnet 74 on the paddle 22 of each respective module 10-1 through 10-N. These Hall-effect sensors were connected by suitable cables to the signal conditioning circuits 80-1 through 80-N of FIG. 1. The signal conditioning circuits 80 each comprise buffer amplifier and comparators 68 and 78 and a flip flop 82. The plurality of modules 10-1 through 10-N were located inside a nitrogen atmosphere box to assure anaerobic operation.

### The Control and Signal Processing Apparatus

In operation the computer 600 commands the programmable power supply 500 (the “control motor speed” signal) to set the speed of the motors 40 in each viscosity measurement module 10. The computer 600 then commands the motor selector unit 550 (the “select motor group” signal) to select one or more motors.

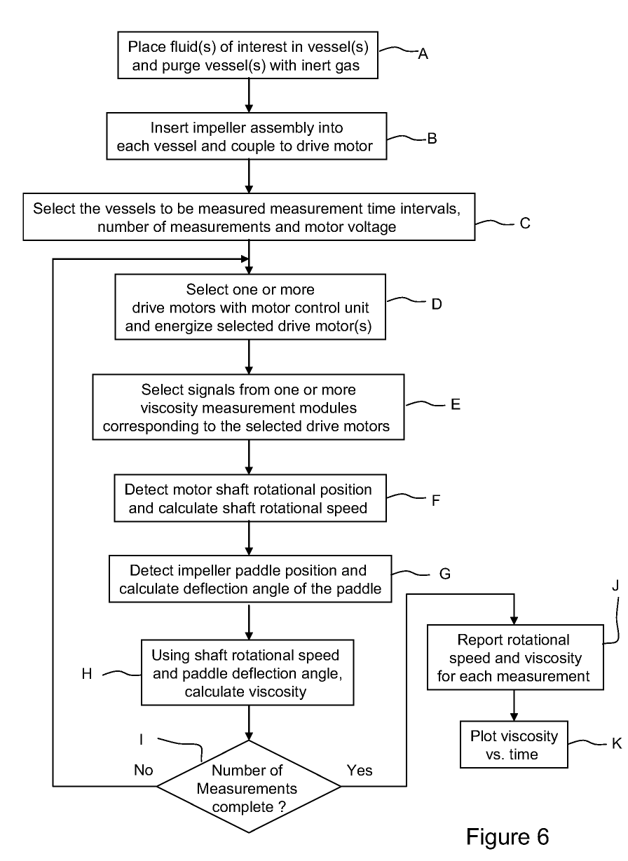

With the DC motor(s) 40 energized the computer 600 commands the multiplexer unit 300 to select the signals from the corresponding module(s) 10 to measure of shaft rotational speed and the deflection angle of the paddle in each module 10. The measured rotational speed and the deflection angle were recorded for each module 10 using the computer control unit 600 according to method diagrammed in FIG. 6, described below.

### Electronic Signal Processing

Attached to the shaft 30 and paddle 22 of the impeller assembly are high strength rare earth magnets 64, 74. The angular rotational positions of the paddle and shaft are sensed by the magnets 64, 74 passing by respective Hall-effect sensors 66, 76.

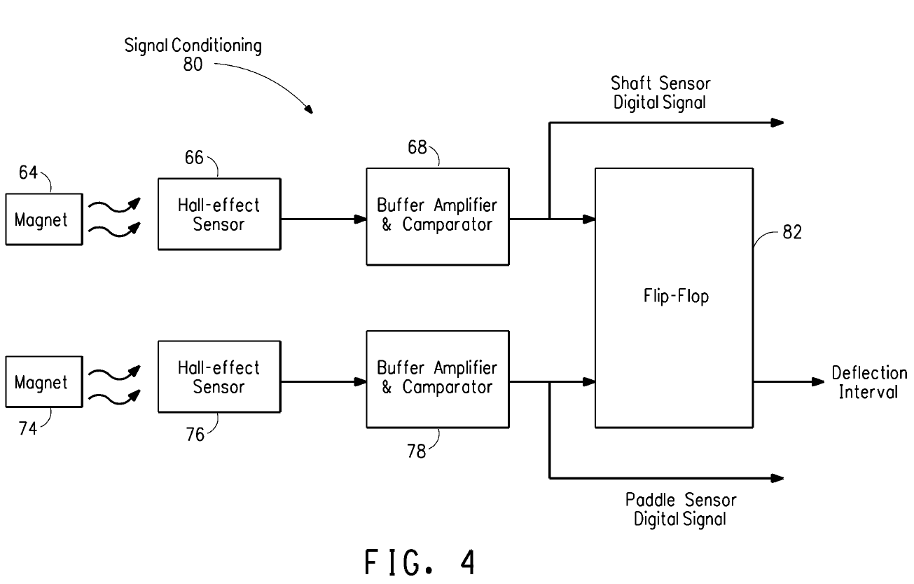

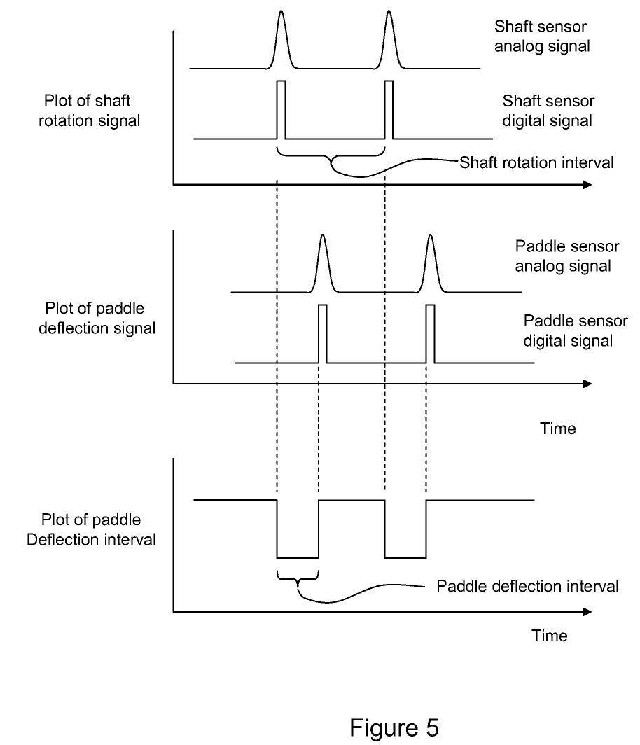

Rotational shaft speed of the impeller assembly is determined by measuring the shaft rotation interval, i.e., the time between pulses produced by the magnet 64 attached to the shaft of viscometer. As the magnet passes by the Hall-effect sensor 66, a voltage pulse is generator from the Hall-effect sensor, as seen in FIG. 5, the waveform labeled “shaft sensor analog signal”. This signal is feed to a voltage comparator 68 (FIG. 4), which produces a digital pulse. This digital pulse as seen in the waveform labeled “shaft sensor digital signal” of this group may be used to start a counter circuit (in the counter unit 400 in measurement unit 100) which counts high frequency clock pulses. After the shaft 30 of the agitator assembly has completed one revolution, the magnet 64 again passes the Hall-effect sensor 66, generating another voltage signal which generates another digital pulse, which is used to stop the counter circuit. The counter circuit thus measures the time interval between occurrences of the digital pulses (the shaft rotation interval) to determine the rate of rotation of the shaft of the agitator assembly in revolutions per minute.

The deflection angle of the paddle is determined by measuring the time interval between the signal generated by the passing of the magnet 64 past the sensor 66 (the “shaft sensor analog signal”) and the signal generated by the passing of the magnet 74 attached to the paddle past the sensor 76, the “paddle sensor analog signal”.

The paddle sensor analog signal is converted to a digital signal by comparator 78 (FIG. 4) in the manner described above. The digital pulse of the “shaft sensor digital signal” waveform may be used to start a second counter circuit (in the counter unit 400 in the measurement unit 100) which counts high frequency clock pulses. The “paddle sensor digital signal” stops the second counter circuit, thus measuring the time between the “shaft sensor digital signal” and the “paddle sensor digital signal” (the “deflection interval”). By calculating the ratio of the “deflection interval” and the “shaft rotation interval” the measurement unit 100 can determine the paddle deflection angle. It should be noted that both the deflection angle and shaft speed are measured in the same rotational period of the shaft to minimize noise in the measurement.

### The Measurement Method

As may be seen in block A of the block diagram of FIG. 6, one or more fluid(s) of interest are a placed in one or more corresponding vessel(s) and the vessel(s) are purged with inert gas. As seen in block B an impeller assembly is inserted into each corresponding vessel and coupled to a drive motor. Alternatively the fluid(s) may be added to vessel(s) with the impeller assemblies already in place. The user selects the modules 10 to be used, the measurement time intervals, the number of measurements and the motor voltage using the computer control unit 600 as shown in block C. The computer control unit then commands the programmable power supply 500 to produce the selected output voltage and selects one or more drive motors 40 with the motor control unit 550 and energizes the selected drive motor(s).

The computer control unit then commands the multiplexer 300 to select signals from one or more viscosity measurement modules 10 corresponding to the selected drive motors 40 (block D). After a suitable time interval the signal conditioning unit 80 then detects the motor shaft rotational position and the paddle deflection angle as the impeller assembly rotates. The counter unit 400 measures the shaft rotation interval and the paddle deflection interval. The computer control unit then calculates shaft rotational speed and the paddle deflection angle (blocks F and G).

Using the shaft rotational speed and the paddle deflection angle, and calibration data for known viscosity fluids the computer control unit calculate the viscosity of the fluid(s) (block H). The steps of blocks D through H are repeated until the selected number of measurements have been completed in accordance with decision block I.

The computer control unit then reports the rotational speed and the calculated viscosity for each measurement (block J). The computer control unit then can plot the viscosity as a function of time for each sample, if desired, in accordance with block K.

### EXAMPLES

Three examples were performed to illustrate the utility and performance capability of this apparatus. Example 1 illustrates how the apparatus was calibrated using Newtonian fluids of known viscosities. Example 2 illustrates the use of the apparatus for an un-inoculated control using real fluids with and without water present to measure their relative viscosities over an extended period of time as would be required for any enrichment culture experiment. Example 3 illustrates the use of the apparatus for an inoculated experiment that shows viscosity changes over time as a result of evaporative losses of light components in the oil.

### Example 1

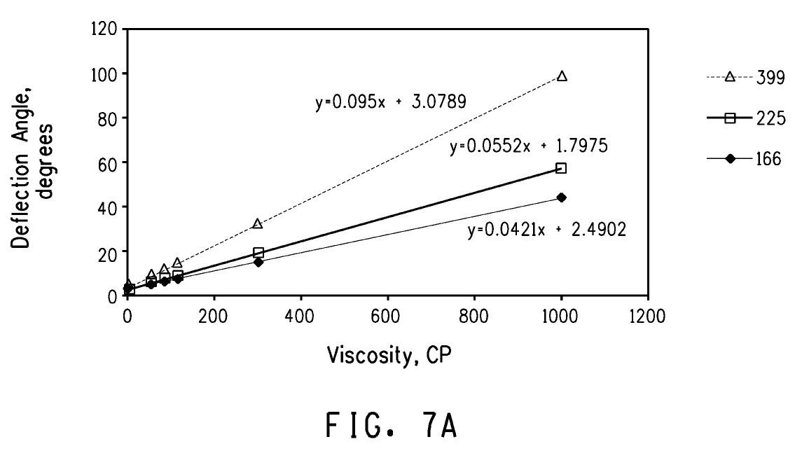

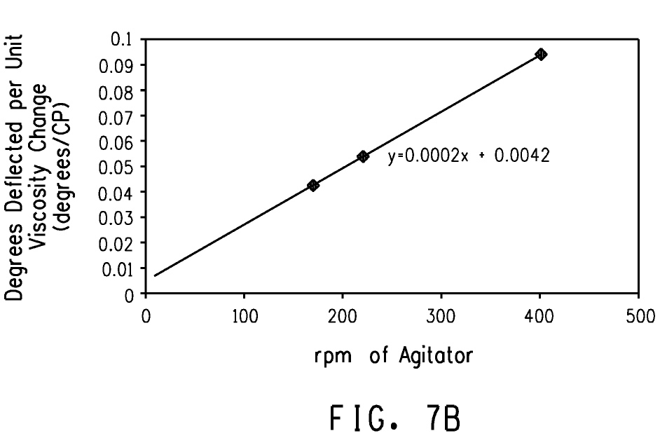

The apparatus and measurement method described above was used on a series of calibration fluids. These fluids were purchased from Brookfield viscosity standards available from Brookfield Engineering Laboratories, Inc, Middleboto, Mass., USA at the following viscosities: 1000 centipoise (cp), 300 cp, 100 cp, 75 cp, 56 cp and 1 cp. For a viscosity of zero, air was used. A fluid volume of 40 ml was placed in each vessel 50-1 through 50-6. The deflection angle of the paddle was measured for each fluid at three different shaft rotational speeds: 399, 225 and 166 revolutions per minute (RPM). The top plot of FIG. 7 shows these deflection angles plotted as a family of curves at each RPM. For example, for the 1000 cp fluid and at shaft speed of 399 RPM, the deflection angle of the paddle was just under 100 degrees from its equilibrium position. At 225 RPM, the paddle had a deflection angle of 58 degrees and at 166 RPM, the deflection angle was 43 degrees. The deflection angle was linearly related to the fluid viscosity as would be anticipated for a Newtonian fluid. This validates the measurement method. The specific deflection angle was measured as a ratio of the change in the deflection angle per unit change in the viscosity of the calibration fluid and is illustrated in the bottom plot of FIG. 7. Again, there is a very linear response indicating that the apparatus is functioning correctly.

### Example 2

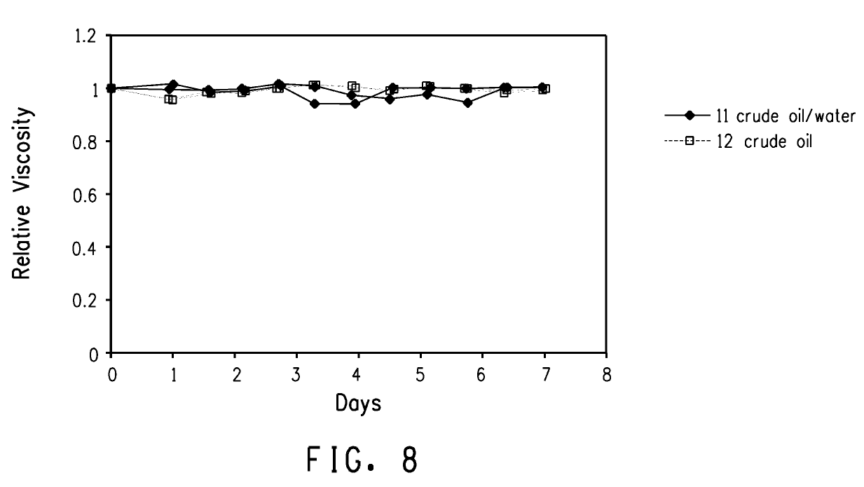

For this example, 40 ml of crude oil was placed in one vessel 50-1 of the apparatus. Approximately 14 ml of crude oil and 26 ml of water were placed in a second vessel 50-2. The relative viscosity of the oil phase of each vessel was measured at predetermined intervals for a full week. The relative viscosity was the relative change in the deflection angle of the paddle at a constant shaft speed. As shown in the plot of FIG. 8, there was essentially no change in the viscosity of the oil when either in contact with the water or not in contact with the water.

### Example 3

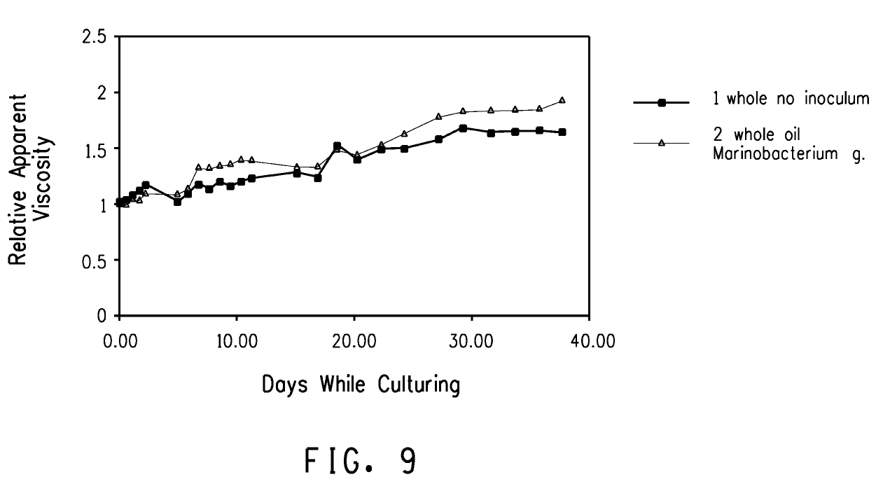

For this example, 14 ml of crude oil and 26 ml of water were placed in one vessel 50-1 of the apparatus. The same 14 ml of crude oil and 26 ml of water were placed in a second vessel 50-2. In this second vessel, 5 milliliters (ml) of an ATCC strain 33635, (Marinobacterium georgiense) at about 10⁸ colony forming units per milliliter (cfu/ml) was used as an inoculum. The relative viscosity was measured each day as the relative change in the deflection angle at a constant RPM for over a month. As shown in the plot of FIG. 9, there was a consistent increase in the viscosity of the oil for both the control as well as the inoculated well. This increase in viscosity was subsequently found to be due to evaporative loss of a small part of the oil since the head space in the vessel was vented into the nitrogen atmosphere chamber.

Those skilled in the art, having the benefit of the teachings of the present invention may impart modifications thereto. Such modifications are to be construed as lying within the scope of the present invention, as defined by the appended claims.

What is claimed is:

1. A method of measuring viscosity of a fluid in a sealed vessel, comprising the steps of:
a) placing a fluid material of interest in a generally cylindrical vessel containing an impeller assembly, the impeller assembly comprising: i) a generally planar impeller paddle, ii) a shaft, iii) a torsional spring, and iv) a drive motor;
b) adding a chemical or biological agent to the fluid material;
c) purging the cylindrical vessel with a predetermined reaction atmosphere and reacting the agent with the fluid;
d) rotating the impeller paddle at a predetermined rotational speed;
e) sensing the rotational position of the shaft and the rotational position of the impeller paddle;
f) determining the rotational speed of the shaft from the sensed rotational position;
g) determining the deflection angle of the impeller paddle relative to the shaft;
h) determining the viscosity of the fluid from the deflection angle and the rotational speed of the shaft;
i) periodically repeating steps d) through h) for a predetermined number of iterations; and
j) reporting the results to a user.

2. The method of claim 1 wherein step e) of sensing the rotational position of the shaft and the rotational position of the impeller paddle is performed using magnetic sensors.

3. The method of claim 1 wherein step e) of sensing the rotational position of the shaft and the rotational position of the impeller paddle is performed using optical sensors.

4. The method of claim 1 wherein step h) of the viscosity is determined from the deflection angle and the rotational speed of the shaft by a calibration table containing deflection angles of fluids with known viscosities.

5. The method of claim 1 wherein steps f) through j) are performed by a computer under the control of instructions stored in a storage device.

6. The method of claim 1 wherein step h) is performed by creating a look up table of known viscosity fluids containing shaft rotational speeds and impeller deflection angles in a storage device and then accessing the look up table with a computer to determine the viscosity of a fluid being measured.

7. A method of calibrating an apparatus for measuring viscosity of a fluid in a sealed vessel, comprising the steps of:
a) placing a fluid material having known viscosity in a generally cylindrical vessel containing an impeller assembly, the impeller assembly comprising: i) a generally planar impeller paddle, ii) a shaft, iii) a torsional spring, and iv) a drive motor;
b) purging the cylindrical vessel with a predetermined atmosphere;
c) rotating the impeller paddle at a predetermined rotational speed;
d) sensing the rotational position of the shaft and the rotational position of the impeller paddle;
e) determining the rotational speed of the shaft from the sensed rotational position;
f) determining the deflection angle of the impeller paddle relative to the shaft;
g) repeating steps c) through f) at a predetermined number of different rotational speeds;
h) repeating steps a) through g) for a predetermined number of fluids having different known viscosities; and
i) assembling the results of each performance of step f) in a look up table.
